(19) United States
(12) Patent Application Publication
(10) Pub. No.: US 2011/0142737 A1
(43) Pub. Date: Jun. 16, 2011

(54) SELECTIVE CATALYTIC REDUCTION OF NITROGEN OXIDES IN THE EXHAUST GAS OF DIESEL ENGINES

(75) Inventors: Michael SEYLER, Rodenbach (DE); Nicola Soeger, Nidderau (DE); Katja Adelmann, Darmstadt (DE); Anke Schuler, Woerth (DE); Thomas R. Pauly, Oberursel (Taunus) (DE); Gerald Jeske, Neuberg (DE)

(73) Assignee: UMICORE AG & CO. KG, Hanau-Wolfgang (DE)

(21) Appl. No.: 12/964,394

(22) Filed: Dec. 9, 2010

(30) Foreign Application Priority Data
Dec. 11, 2009 (EP) 09015346.1

(51) Int. Cl. B01D 53/94; B01J 29/70; B01J 29/85; B01J 29/83

(52) U.S. Cl. 423/213.2; 502/73; 502/65

(57) ABSTRACT

A catalyst and a process for selective catalytic reduction of nitrogen oxides in diesel engine exhaust gases with ammonia or a compound decomposable to ammonia are described. The exhaust gas to be cleaned is passed together with ammonia or a compound decomposable to ammonia over a catalyst which comprises a zeolite or a zeolite-like compound containing 1-10% by weight of copper, based on the total weight of the zeolite or of the zeolite-like compound, and a homogeneous cerium-zirconium mixed oxide and/or a cerium oxide. The zeolite used or the zeolite-like compound used is selected from the group consisting of chabazite, SAPO-34, ALPO-34 and zeolite-β.

The invention relates to a catalyst and to a process for selective catalytic reduction of nitrogen oxides in diesel engine exhaust gases with ammonia or a compound decomposable to ammonia.

### BACKGROUND

In addition to the pollutant gases which result from incomplete combustion of the fuel, these being carbon monoxide (CO) and hydrocarbons (HC), the exhaust gas of diesel engines comprises particulate material (PM) and nitrogen oxides (NOₓ). In addition, the exhaust gas of diesel engines contains up to 15% by volume of oxygen. It is known that the oxidizable pollutant gases, CO and HC, can be converted to harmless carbon dioxide (CO₂) by passing them over a suitable oxidation catalyst, and particulates can be removed by passing the exhaust gas through a suitable particulate filter. Technologies for removal of nitrogen oxides from exhaust gases in the presence of oxygen are also well known in the prior art. One of these “denoxing” processes is the SCR process (SCR=Selective Catalytic Reduction), i.e. the selective catalytic reduction of the nitrogen oxides with the reducing agent ammonia over a catalyst suitable therefor, the SCR catalyst. It is possible to add ammonia as such to the exhaust gas stream, or in the form of a precursor compound decomposable to ammonia under ambient conditions, “ambient conditions” being understood to mean the environment of the compounds decomposable to ammonia in the exhaust gas stream upstream of the SCR catalyst. To perform the SCR process, a source for providing the reducing agent, an injection apparatus for metered addition of the reducing agent as required into the exhaust gas and an SCR catalyst arranged in the flow path of the exhaust gas are needed. The totality of reducing agent source, SCR catalyst and injection apparatus arranged on the inflow side to the SCR catalyst is also referred to as an SCR system.

For cleaning of the diesel exhaust gases in motor vehicles, the SCR system is usually used in combination with other exhaust gas cleaning units such as oxidation catalysts and diesel particulate filters. This gives rise to many different options for exhaust gas system configuration. According to the installation position of the SCR system, and more particularly according to the arrangement of the SCR catalyst in the flow path of the exhaust gas, different requirements are made on the performance and aging stability thereof. Consequently, the prior art has described a multitude of SCR catalysts which are suitable for reduction of the nitrogen oxide content in the exhaust gas of diesel engines and which are usually optimized according to the specific demands on the particular exhaust gas system configuration.

For example, EP 1 203 611 discloses an SCR catalyst which is used preferentially in combination with an upstream oxidation catalyst. The SCR catalyst comprises an NOₓ storage component as well as an SCR-active component. The SCR component used may be a TiO₂/VOₓ-based solid acid system which optionally also comprises WO₃, MoO₃, SiO₂, sulfate or zeolite. A further option for the SCR component is a zeolite of the acidic H⁺ form or a metal ion-exchanged zeolite. The NOₓ storage component used is preferably a compound of the elements selected from the group consisting of alkali metals, alkaline earth metals and cerium. In addition, the catalyst may optionally comprise platinum group metals (Pt, Pd, Rh, Ir) as catalytically active components, which are applied to the nitrogen oxide storage component and/or to a support material selected from aluminum oxide, cerium oxide, zirconium oxide, titanium oxide or mixed oxides thereof.

EP 0 234 441 discloses a catalyst for the selective catalytic reduction of NOₓ to nitrogen in the presence of ammonia, which consists to an extent of 5 to 50% by weight of zirconium oxide starting material with a specific surface area of at least 10 m²/g, to an extent of 50 to 90% of one or more zeolites in the hydrogen or ammonium form, and to an extent of 0 to 30% of binder. The zeolites used are preferably clinoptilolite, optionally in a blend with chabazite. In addition, the catalyst may comprise vanadium oxide and/or copper oxide as promoters.

U.S. Pat. No. 4,874,590 discloses a process for catalytic reduction of the level of nitrogen oxides, and also sulfur oxides, from gas streams by passing the gas stream together with ammonia over a microporous, non-zeolitic molecular sieve. This molecular sieve is preferably selected from the group of the SAPOs, ELAPSOs, AlPO₄S, MeAlPOs, FeAPOs, TAPOs, ELAPOs and MeAFSOs. Metal ions selected from Cu, Co, V, Cr, W, Ni, Pd, Pt, Mn, Mo, Rh, Mg, Al and Fe may be exchanged into the molecular sieve, particular preference being given to using Cu as the exchange ion. The non-zeolitic molecular sieve composition is optionally present supported in an inorganic oxidic matrix, for which it is customary to use amorphous, catalytically active, inorganic oxides such as silica/alumina, alumina, SiO₂, Al₂O₃, mixed oxides of SiO₂ with Al₂O₃, ZrO₂, MgO, thorium oxide, beryllium oxide, Si—Al—Th mixed oxides, Si—Al—Zr mixed oxides, Al—B mixed oxides, aluminum titanates and the like.

WO 2005/088091 discloses a process for reducing nitrogen oxides in diesel exhaust gases using fuel (hydrocarbons) instead of ammonia or a compound decomposable to ammonia as the reducing agent. In this process, a catalyst which comprises an NOₓ-absorbing material and an NOₓ-reducing material is used. Both materials are selected from the group comprising natural, synthetic, ion-exchanging, non-ion-exchanging, modified, unmodified, pillared, non-pillared clay minerals, sepiolites, attapulgites, natural, synthetic, ion-exchanging, non-ion-exchanging, modified, unmodified zeolites, Cu, Ba, K, Sr, and Ag-laden, Al-, Si- and Ti-pillared montmorillonites, hectorites doped with Fe, In, Mn, La, Ce or Cu, and mixtures thereof, Cu-, Fe-, Ag-, Ce-laden clinoptilolites, and mixtures thereof. In preferred embodiments, blends of zeolites with clay minerals and copper are used as the catalytically active components.

U.S. Pat. No. 7,220,692 likewise discloses a catalyst which is suitable for the reduction of nitrogen oxides in lean combustion exhaust gases using hydrocarbons as the reducing agent. This catalyst is bifunctional and combines active, metal-exchanged molecular sieves with a separate stabilizing metal oxide phase which is obtained from a sol precursor compound as a coating over the molecular sieve particles, and brings about an improved hydrothermal stability with simultaneous retention of the low-temperature NO reduction activity. The metal-exchanged molecular sieves used are preferably those whose pore sizes are at least 4 Å (zeolite Y, zeolite β, mordenite, ferrierite, ZSM-5, ZSM-12), and which comprise, as promoters, one or more of the transition metals Cu, Co, Fe, Ag and Mo.

### SUMMARY OF INVENTION EXAMPLES

It is an object of the present invention to provide a catalyst and a process for selective catalytic reduction of nitrogen oxides in diesel engine exhaust gases with ammonia or a compound decomposable to ammonia. The catalyst used in the process should be notable especially for an improved conversion activity in the reduction of NOₓ with ammonia at temperatures above 350° C. with simultaneously excellent selectivity for nitrogen. At the same time, no activity losses whatsoever compared to conventional catalysts should be observed within the temperature range between 250 and 350° C. and especially within the low-temperature range between 150 and 250° C.

This object is achieved by a catalyst for selective catalytic reduction of nitrogen oxides in diesel engine exhaust gases with ammonia or a compound decomposable to ammonia, consisting of a substrate and a catalytically active coating applied thereto comprising
a zeolite or a zeolite-like compound containing 1-10% by weight of copper, based on the total weight of the zeolite or of the zeolite-like compound, said zeolite or said zeolite-like compound being selected from the group consisting of chabazite, SAPO-34, ALPO-34 and zeolite β; and
a homogeneous cerium-zirconium mixed oxide and/or a cerium oxide.

The inventive catalyst is used in a process for selective catalytic reduction of nitrogen oxides in diesel engine exhaust gases, comprising the following process steps: (a.) adding ammonia or a compound decomposable to ammonia from a source independent of the engine to the exhaust gas which comprises nitrogen oxides and is to be cleaned; (b.) passing the mixture, obtained in step (a.), of exhaust gas to be cleaned and ammonia or a compound decomposable to ammonia over the inventive catalyst.

It is known in principle that copper-exchanged zeolites or copper-exchanged zeolite-like compounds are suitable for denoxing of diesel exhaust gases when ammonia or a suitable compound decomposable to ammonia, for example urea, is used as the reducing agent. Corresponding catalysts known from the prior art are notable for good NOₓ conversion activities at temperatures below 300° C., but have disadvantages at higher temperatures and especially at temperatures above 350° C. Within this temperature range, the oxidizing power of the copper frequently results in overoxidation of ammonia to form dinitrogen monoxide N₂O as a secondary emission which is undesired because it is toxic. The overoxidation of the ammonia reducing agent results not only in the emission of dinitrogen monoxide but also in a significant degradation of the NOₓ conversion above 350° C. Comparative example 2 in conjunction with FIG. 2 shows a typical NOₓ conversion profile of a copper-exchanged zeolite catalyst (CC2) using ammonia as the reducing agent. It is clearly evident that the NOₓ conversion over CC2 decreases with rising temperature above 350° C. This property restricts the suitability of these catalysts to use at temperatures below 350° C.

The inventors have now found that, surprisingly, this restriction of suitability can be at least partly overcome by the controlled blending of the copper-exchanged zeolite or of the copper-exchanged zeolite-like compound with an untreated homogeneous cerium-zirconium mixed oxide and/or cerium oxide. This effect is especially surprising because homogeneous cerium-zirconium mixed oxides and/or cerium oxides in the untreated state do not normally exhibit any NOₓ reduction activity. On the contrary: at temperatures above 350° C., overoxidation of the ammonia added as a reducing agent to dinitrogen monoxide and hence the formation of additional N₂O and adverse NOₓ conversion are likewise observed in lean, nitrogen oxide-containing diesel exhaust gas over an untreated, homogeneous cerium-zirconium mixed oxide. FIG. 1 shows, by way of example, the conversion behavior observed under conditions of the standard ammonia SCR reaction over an untreated cerium-zirconium mixed oxide composed of 86% by weight of CeO₂, 10% by weight of ZrO₂ and 4% by weight of La₂O₃ (CC1 from comparative example 1).

For a physical mixture of the copper-exchanged zeolite or of a copper-exchanged zeolite-like compound, it would thus be expected that the NOₓ conversion worsens at temperatures above 350° C. and the proportion of the N₂O arising from the overoxidation of ammonia rises further. Owing to a surprising, synergistic interaction of the two components, however, the opposite is the case: as evident from example 1 in conjunction with FIG. 2, an inventive catalyst (C1) which comprises a blend of the copper-exchanged zeolite or of a zeolite-like compound with an untreated homogeneous cerium-zirconium mixed oxide composed of 86% by weight of CeO₂, 10% by weight of ZrO₂ and 4% by weight of La₂O₃ surprisingly exhibits a distinct improvement in the NOₓ conversion at temperatures above 350° C. At the same time, the excellent conversion properties typical of the copper zeolite catalyst within the temperature range between 250 and 350° C. and especially within the low-temperature range between 150 and 250° C. are maintained. The formation of dinitrogen monoxide is surprisingly not increased, but remains at the same level or is improved slightly, such that the selectivity for nitrogen is considerably better than would be expected by additive interaction of the components.

The coating present in the inventive catalysts consists preferably to an extent of 70-100% by weight, based on the total amount of the coating, of a physical mixture of the zeolite or of the zeolite-like compound with the homogeneous cerium-zirconium mixed oxide and/or the cerium oxide. In this physical mixture, the zeolite or the zeolite-like compound and the homogeneous cerium-zirconium mixed oxide and/or the cerium oxide are present preferably in a weight ratio of 4:1 to 2:1, more preferably in a weight ratio of 3:1 to 2:1 and most preferably in a weight ratio of 2:1. The weight ratio is understood to mean the ratio of the proportions by weight (% by weight) of the components in the coating relative to one another.

The zeolites or the zeolite-like compounds used are preferably those which have a mean pore size less than 4 Angstrom (Å) and are selected from the group consisting of chabazite, SAPO-34 and ALPO-34. Particular preference is given to using the zeolite-like molecular sieves SAPO-34 and ALPO-34. SAPO-34 is a zeolite-analogous silicoaluminophosphate molecular sieve with chabazite structure, ALPO-34 a zeolite-analogous aluminophosphate with chabazite structure. These compounds have the advantage of being resistant toward poisoning with hydrocarbons (HC) which are present in the untreated diesel exhaust gas and which can cause, according to the installation position of the SCR catalyst and operating state of the diesel engine, distinct degradation of the nitrogen oxide conversion over conventional SCR catalysts.

In conventional copper-exchanged zeolite catalysts which typically have mean average pore sizes of at least 4 Å, it has been observed that hydrocarbons (HC) are intercalated into the pore structure of the zeolite under the conditions of the ammonia SCR reaction in the presence of these hydrocarbons. It is assumed that these intercalated hydrocarbons at least temporarily block the reactive sites for the ammonia SCR reaction.

The overall result is that increased ammonia breakthroughs and worsened nitrogen oxide conversions are observed under the reaction conditions of the ammonia SCR reaction over conventional copper-exchanged zeolite catalysts in the presence of hydrocarbons in the exhaust gas to be cleaned. Use of a zeolite or of a zeolite-like compound with a mean pore size less than 4 Angstrom (Å), which is selected from the group consisting of chabazite, SAPO-34 and ALPO-34, prevents such HC-related poisoning phenomena. The low mean pore size of these compounds prevents hydrocarbons from penetrating into the pore structure of the zeolite, and thus being able to block the reactive sites for the ammonia SCR reaction. SAPO-34 and ALPO-34 are additionally notable for excellent thermal stability of the ammonia storage capacity thereof. As a result, very good nitrogen oxide conversion rates with simultaneously high selectivity for nitrogen and only low ammonia breakthroughs are observed even in HC-containing exhaust gas over the preferred embodiments of the inventive catalyst which comprise these zeolite-like compounds.

The homogeneous cerium-zirconium mixed oxides used in the inventive catalyst are preferably high-surface area mixed oxides of cerium and of zirconium, in which a majority of mixed crystals of cerium oxide and zirconium oxide are present. The term “solid solution” of cerium oxide and zirconium oxide is also used for such compounds. The cerium-zirconium mixed oxides used in the inventive catalysts contain preferably 40 to 98% by weight of CeO₂, based on the total weight of the mixed oxides. It is also possible to use pure cerium oxide. Particular preference is given to using high-surface area homogeneous cerium-zirconium mixed oxides and/or high-surface area cerium oxide doped with 1-20% by weight, based on the total weight of the mixed oxide, of the oxide of one or more rare earth metals selected from the group consisting of lanthanum, yttrium, neodymium, praseodymium and samarium, and/or with niobium oxide. Such dopants may bring about, inter alia, stabilization of the high surface area of the material under hydrothermal ambient conditions. “High-surface area” oxides are understood to mean materials with a BET surface area of at least 10 m²/g, preferably at least 50 m²/g, more preferably at least 70 m²/g.

In addition, the catalytically active coating of preferred embodiments of the inventive catalyst comprises a high-surface area aluminum oxide optionally stabilized with rare earth sesquioxide. Such aluminum oxides are commercially available and typically have, in the untreated state, BET surface areas of more than 100 m²/g. They are preferably doped with 1 to 10% by weight, based on the total weight of the aluminum oxide, of an oxide of one or more rare earth metals selected from the group consisting of lanthanum, yttrium, neodymium, praseodymium and samarium. The addition of such an oxide to the coating brings about an improvement in the thermal aging stability of the inventive catalysts.

### BRIEF DESCRIPTION OF DRAWINGS

FIG. 1 shows the NO conversions observed during a test of the catalyst activity of comparative component CC1.

FIG. 2 shows the results of a steady-state test of the conversion behavior of the comparative component CC1 and invention catalyst C1.

FIG. 3 shows the conversion behavior of comparative catalyst CC2 and catalyst C1 under dynamic operating conditions.

FIG. 4 shows the result of a steady state test after synthetic aging relative to comparative catalyst CC3 and catalyst C2.

FIG. 5 shows a dynamic test carried out relative to comparative catalyst CC4 and catalyst C2.

FIG. 6 shows the activity results achieved for comparative catalyst CC5 in the steady-state test in comparison to catalysts C1 and C2.

### DETAILED DESCRIPTION

The inventive catalysts are notable for high NO conversion rates within the temperature range from 200 to 500° C. with simultaneously excellent selectivity for nitrogen, especially in the high-temperature range above 350° C. One reason for the markedly good selectivity performance and the very low tendency of the inventive catalysts to overoxidation of ammonia is that the inventive catalysts do not contain any platinum group metal. More particularly, the catalytically active coating of the inventive catalysts does not contain any metal selected from the group consisting of platinum, palladium, rhodium, iridium and ruthenium. Even very small amounts of these noble metals in the catalytically active coating of the inventive catalysts would cause overoxidation of ammonia to dinitrogen monoxide N₂O in the lean diesel exhaust gas owing to the strong oxidation-catalyzing action thereof, and hence destroy the high selectivity for nitrogen. It should therefore be ensured in the production of the inventive catalysts that there cannot be any contamination of the catalytically active coating with noble metals either as a result of the raw materials used or as a result of the apparatus used.

The best embodiment of the inventive catalyst known to the inventors consists of a substrate and a catalytically active coating applied thereto, which is composed of:
50-60% by weight of zeolite or a zeolite-like compound containing 1-10% by weight of copper, based on the total weight of the zeolite or of the zeolite-like compound, said zeolite or said zeolite-like compound being selected from the group consisting of chabazite, SAPO-34, ALPO-34 and zeolite β;
25-30% by weight of homogeneous cerium-zirconium mixed oxide and/or cerium oxide;
8-10% by weight of high-surface area aluminum oxide optionally stabilized with rare earth sesquioxide;
balance: calcination product of an inorganic binder selected from silica sol, alumina sol, silica-alumina sol and zirconium oxide sol.

The zeolite or zeolite-like compound used therein preferably has an average mean pore size less than 4 Ångstrom, and is selected from the group consisting of chabazite, SAPO-34 and ALPO-34. It is most preferably SAPO-34 and/or ALPO-34.

Suitable support bodies for the catalytically active coating are in principle all known support bodies for heterogeneous catalysts. Preference is given to using monolithic and monolith-like flow honeycombs composed of ceramic and metal, and also particulate filter substrates as typically used for cleaning of diesel engine exhaust gases. Very particular preference is given to ceramic flow honeycombs and ceramic wall-flow filter substrates composed of cordierite, aluminum titanate or silicon carbide.

The inventive catalyst is suitable for removal of nitrogen oxides from the exhaust gas of diesel engines in a process for selective catalytic reduction thereof, comprising the following process steps:
a. adding ammonia or a compound decomposable to ammonia from a source independent of the engine to the exhaust gas which comprises nitrogen oxides and is to be cleaned;
b. passing the mixture, obtained in step a., of exhaust gas to be cleaned and ammonia or a compound decomposable to ammonia over the inventive catalyst.

The invention is illustrated in detail hereinafter with reference to some examples and figures.

Inventive catalysts and some comparative catalysts were produced. For this purpose, ceramic honeycombs having a diameter of 93 mm and a length of 76.2 mm, which had 62 cells per cm² with a cell wall thickness of 0.17 mm, were coated with coating suspensions of the composition specified below by a conventional dipping process. After the coating suspension had been applied, the honeycombs were dried in a hot air blower and calcined at 640° C. for a duration of 2 hours.

The loadings specified in the examples and comparative examples apply to the finished catalysts after drying and calcination. The figures in g/l each relate to the volume of the overall catalyst.

Drill cores were taken from the catalysts thus produced to examine the catalytic activity thereof. These specimens had a diameter of 25.4 mm and a length of 76.2 mm. Unless stated otherwise, the specimens, before being examined for catalytic activity, were subjected to synthetic aging by storage in an oven in an atmosphere of 10% by volume of water vapor and 10% by volume of oxygen in nitrogen at 750° C. for 16 hours.

Subsequently, the activity of the catalysts was examined in a laboratory model gas system. For this purpose, a steady-state test and/or a dynamic activity test was carried out. The test conditions are described hereinafter:

### Steady-State Test:

To examine the conversion behavior of the catalysts under steady-state operating conditions, the following parameters were established:

Composition of the model gas

| | |
|---|---|
| NO [ppmV]: | 500 |
| NH₃ [ppmV]: | 450 |
| O₂ [% by vol.] | 5 |
| H₂O [% by vol.] | 1.3 |
| N₂: | Balance |

General test conditions

| | |
|---|---|
| Space velocity [h⁻¹]: | 30 000 |
| Temperature [° C.] | 500; 450; 400; 350; 300; |
| | 250; 200; 175; 150 |
| Conditioning before | Model gas atmosphere; 600° C.; |
| commencement of analysis: | a few minutes |

During the analysis, the nitrogen oxide concentrations of the model exhaust gas downstream of the catalyst were detected with a suitable analysis method. The known nitrogen oxide dosages, which were verified during the conditioning with a pre-catalyst exhaust gas analysis at the start of the particular test run, and the measured nitrogen oxide contents downstream of the catalyst were used to calculate the nitrogen oxide conversion over the catalyst for each temperature measurement point as follows:

$${C}_{{NO}_{x}} [ \% ] = [ 1 - \frac{{c}_{outlet} ( {NO}_{x} )}{{c}_{inlet} ( {NO}_{x} )} ] \cdot 100$$

where c_{inlet/outlet}(NOₓ)=c_{in/out}(NO)+c_{in/out}(NO₂)

The resulting nitrogen oxide conversion values C_{NOx} [%] were plotted as a function of the temperature measured upstream of the catalyst to assess the SCR activity of the materials examined.

### Dynamic Activity Test:

In the dynamic activity test, the following gas mixtures were used:

| | Gas mixture | | |
|---|---|---|---|
| Constituent | Gas mixture 1 | Gas mixture 2 | Gas mixture 3 |
| O₂ [% by vol.]: | 10 | 10 | 10 |
| NO [ppmV]: | 500 | 500 | 0 |
| NH₃ [ppmV]: | 0 | 750 | 0 |
| CO [ppmV]: | 350 | 350 | 350 |
| C₃H₆ [ppmV]: | 100 | 100 | 100 |
| H₂O [ppmV] | 5 | 5 | 5 |
| N₂ [% by vol.]: | balance | balance | balance |
| Space velocity [h⁻¹] | 60 000 | 60 000 | 60 000 |

The test was carried out at nine different temperatures between 175° C. and 500° C. (500, 450, 400, 350, 300, 250, 225, 200 and 175° C.). At each temperature, a cycle composed of four different phases was passed through, which are referred to hereinafter as phases A to D:
Phase A: gas mixture 1; duration: 5 minutes
Phase B: NH₃ SCR phase:
   gas mixture 2; duration: until an NH₃ breakthrough of 20 ppmV or stoppage according to time;
Phase C: gas mixture 3; emptying of the NH₃ store by means of temperature ramp to 500° C.;
Phase D: gas mixture 3; setting of the next measurement temperature.

Within a cycle, the catalyst temperature was first set to the defined target temperature. Then the catalyst was contacted with gas mixture 1 for 5 minutes (phase A). In phase B, the gas mixture was switched to gas mixture 2 in order to determine the NH₃ SCR conversion. This phase was stopped either on detection of an NH₃ breakthrough of 20 ppmV or by a preset time criterion. Then gas mixture 3 was established, and the catalyst was heated up to 500° C. in order to empty the ammonia store (phase C). Subsequently, the catalyst was cooled down to the next measurement temperature to be examined (phase D); the next cycle began with phase A by establishing gas mixture 1 after the target temperature had been set.

The dynamic NOₓ conversion was determined for all nine measurement temperatures from the concentrations of the corresponding exhaust gas components upstream and downstream of the catalyst, determined during phase B. For this purpose, a mean NOₓ conversion over this phase was calculated as follows, taking account of N₂O formation:

$${C}_{mean , {N}_{2} O corr} = [ 1 - \frac{{c}_{{NO}_{x} , mean}^{downstreamofcat} + 2 \cdot {c}_{{N}_{2} O , mean}^{downstreamofcat}}{{c}_{{NO}_{x} , mean}^{upstreamofcat} + 2 \cdot {c}_{{N}_{2} O , mean}^{upstreamofcat}} ] 100 \%$$

The following catalysts were produced and examined:

### Comparative Example 1

A comparative component CC1 was produced in order to examine the reaction behavior of untreated homogeneous cerium-zirconium mixed oxide in the ammonia SCR reaction. For this purpose, a ceramic honeycomb of the abovementioned type was coated in a conventional dipping process with 200 g/l of an untreated homogeneous cerium-zirconium mixed oxide composed of 86% by weight of CeO₂, 10% by weight of ZrO₂ and 4% by weight of La₂O₃, and calcined at 500° C. for a duration of 2 hours.

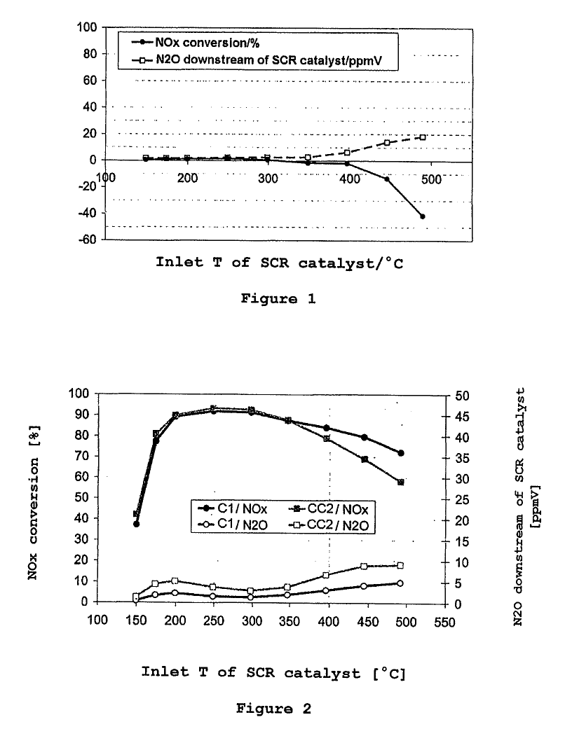

The catalytic activity of the freshly produced component CC1 was examined in a steady-state test. FIG. 1 shows the NOₓ conversions observed during the test. It is clearly evident that nitrogen oxides and N₂O are formed from the overoxidation of the ammonia used as a reducing agent across the component at temperatures from 400° C. No nitrogen oxide conversion is observed in the rest of the temperature range.

### Comparative Example 2

To produce a prior art catalyst, CC2, a ceramic honeycomb was provided with 160 g/l of the copper-exchanged zeolite-like compound SAPO-34. For this purpose, commercially available SAPO-34 was suspended in water. Copper(II) nitrate solution was added to the suspension while stirring. The amount of the copper nitrate solution added was calculated such that the finished catalyst contained 3% by weight of Cu, based on the total weight of the exchanged zeolite-like compound. The suspension was stirred overnight. Subsequently, commercially available silica sol was added as a binder, and the amount of the sol was calculated such that the finished catalyst contained 16 g/l of SiO₂ in an adhesion-promoting function. The suspension was ground and applied to the honeycomb in a conventional coating process. The coated honeycomb was dried and calcined.

### Example 1

According to the procedure outlined in comparative example 2, an inventive catalyst C1 was produced, the catalytically active composition of which had the following composition:
96 g/l of SAPO-34 exchanged with 3% by weight of Cu
48 g/l of homogeneous cerium-zirconium mixed oxide composed of 86% by weight of CeO₂, 10% by weight of ZrO₂ and 5% by weight of La₂O₃
16 g/l of aluminum oxide containing 4% by weight of La₂O₃
16 g/l of SiO₂ from commercially available silica sol as a binder

The conversion behavior of the catalysts CC1 and C1 in the ammonia SCR reaction was examined after aging in a steady-state test and under dynamic conditions. FIG. 2 shows the results of the steady-state test. Above 350° C., the inventive catalyst C1 shows significant conversion advantages over the prior art catalyst CC2 which contains only the copper-exchanged zeolite-like compound SAPO-34. Surprisingly, the addition of the homogeneous cerium-zirconium mixed oxide leads, at temperatures above 350° C., not only to a distinct improvement in the NOₓ conversion but also to a slight decrease in N₂O formation. This is surprising especially because the cerium-zirconium mixed oxide added, as shown in comparative example 1, should actually contribute to N₂O formation within this temperature range.

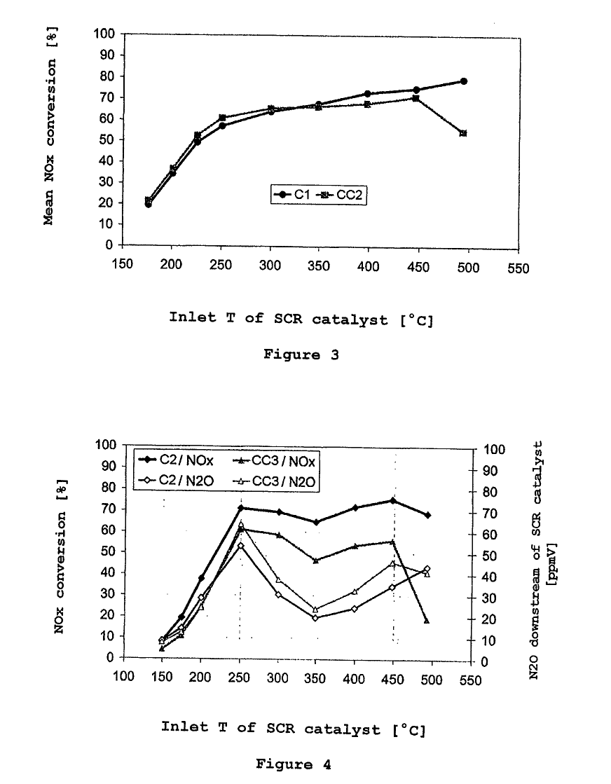

FIG. 3 shows the conversion behavior of the catalysts CC2 and C1 under dynamic operating conditions. The result of the steady-state test is confirmed.

### Comparative Example 3

A prior art catalyst CC3 was produced with a catalytically active coating of the following composition:
160 g/l of β-zeolite exchanged with 5% by weight of Cu;
16 g/l of SiO₂ from commercially available silica sol as a binder

### Comparative Example 4

A comparative example CC4 was produced, the catalytically active coating of which consisted completely of Cu-exchanged β-zeolite:
160 g/l of β-zeolite exchanged with 5% by weight of Cu;

### Example 2

A further inventive catalyst C2 was produced with a catalytically active coating of the following composition:
96 g/l of β-zeolite exchanged with 5% by weight of Cu;
48 g/l of homogeneous cerium-zirconium mixed oxide composed of 86% by weight of CeO₂, 10% by weight of ZrO₂ and 5% by weight of La₂O₃
16 g/l of aluminum oxide containing 4% by weight of La₂O₃
16 g/l of SiO₂ from commercially available silica sol as a binder

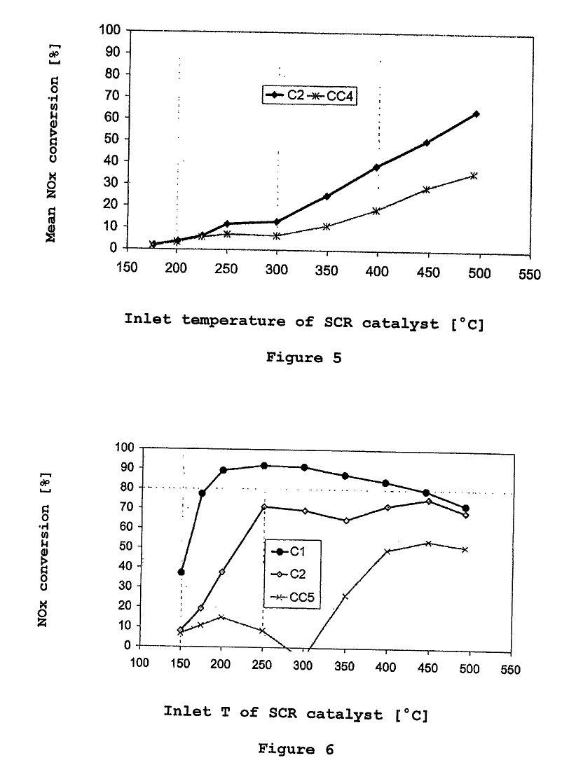

The catalysts CC3 and C2 were subjected to the steady-state test after synthetic aging. FIG. 4 shows the result. The improvement in the nitrogen oxide conversion achieved by the blending with the cerium-zirconium oxide under steady-state conditions has an even clearer effect on a commercial Cu-exchanged β-zeolite SCR catalyst after aging than on the SAPO-34-based catalyst (CC2//C1). More particularly, the inventive catalyst C2, even from 200° C., exhibits distinct improvements in the NOₓ conversion behavior. The effect here is thus not limited to the high-temperature range from 350° C., but is already clearly visible in the moderate temperature range from 200° C. This is also confirmed in the dynamic test (FIG. 5; CC4//C2).

### Comparative Example 5

In addition, the influence of blending with a homogeneous cerium-zirconium mixed oxide on a copper-exchanged Cu-ZSM-5 catalyst was examined. For this purpose, a catalyst was produced with a coating of the following composition:
96 g/l of ZSM-5-zeolite exchanged with 5% by weight of Cu;
48 g/l of homogeneous cerium-zirconium mixed oxide composed of 86% by weight of CeO₂, 10% by weight of ZrO₂ and 5% by weight of La₂O₃
16 g/l of aluminum oxide containing 4% by weight of La₂O₃
16 g/l of SiO₂ from commercially available silica sol as a binder

This catalyst CC5 too was subjected to a steady-state test after aging. However, the result was disappointing. For unknown reasons, no synergistic improvement in conversion resulting from blending of the homogeneous cerium-zirconium mixed oxide was observed for Cu-ZSM-5. FIG. 6 shows the activity results achieved for CC5 in the steady-state test in comparison to C1 and C2.

1. A catalyst for selective catalytic reduction of nitrogen oxides in diesel engine exhaust gases with ammonia or a compound decomposable to ammonia, consisting of a substrate and a catalytically active coating applied thereto comprising
a zeolite or a zeolite-like compound containing 1-10% by weight of copper, based on the total weight of the zeolite or of the zeolite-like compound, said zeolite or said zeolite-like compound being selected from the group consisting of chabazite, SAPO-34, ALPO-34 and zeolite β; and
a homogeneous cerium-zirconium mixed oxide and/or a cerium oxide.

2. The catalyst as claimed in claim 1, wherein
the coating present in the catalyst consists to an extent of 70-100% by weight, based on the total amount of the coating, of a physical mixture of the zeolite or of the zeolite-like compound with the homogeneous cerium-zirconium mixed oxide and/or the cerium oxide.

3. The catalyst as claimed in claim 2, wherein
the zeolite or the zeolite-like compound and the homogeneous cerium-zirconium mixed oxide and/or the cerium oxide are present in the physical mixture in a weight ratio of 4:1 to 2:1.

4. The catalyst as claimed in any of claims 1 to 3, wherein
the zeolite or the zeolite-like compound has an average mean pore size less than 4 Angstrom and is selected from the group consisting of chabazite, SAPO-34 and ALPO-34.

5. The catalyst as claimed in claim 4, wherein
the catalytically active coating further comprises a high-surface area aluminum oxide optionally stabilized with rare earth sesquioxide.

6. The catalyst as claimed in claim 1, wherein
the catalytically active coating does not comprise a platinum group metal, more particularly a metal selected from the group consisting of platinum, palladium, rhodium, iridium and ruthenium.

7. A catalyst for selective catalytic reduction of nitrogen oxides in diesel engine exhaust gases with ammonia or a compound decomposable to ammonia, consisting of a substrate and a catalytically active coating applied thereto, said catalytically active coating having the following composition:
50-60% by weight of zeolite or a zeolite-like compound containing 1-10% by weight of copper, based on the total weight of the zeolite or of the zeolite-like compound, said zeolite or said zeolite-like compound being selected from the group consisting of chabazite, SAPO-34, ALPO-34 and zeolite β;
25-30% by weight of homogeneous cerium-zirconium mixed oxide and/or cerium oxide;
8-10% by weight of high-surface area aluminum oxide optionally stabilized with rare earth sesquioxide;
balance: calcination product of an inorganic binder selected from silica sol, alumina sol, silica-alumina sol and zirconium oxide sol.

8. The catalyst as claimed in claim 7, wherein
the zeolite or the zeolite-like compound has an average mean pore size less than 4 Angstrom and is selected from the group consisting of chabazite, SAPO-34 and ALPO-34.

9. A process for selective catalytic reduction of nitrogen oxides in diesel engine exhaust gases, comprising the following process steps:
a. adding ammonia or a compound decomposable to ammonia from a source independent of the engine to the exhaust gas which comprises nitrogen oxides and is to be cleaned;
b. passing the mixture, obtained in step a., of exhaust gas to be cleaned and ammonia or a compound decomposable to ammonia over a catalyst consisting of a substrate and a catalytically active coating applied thereto, comprising
a zeolite or a zeolite-like compound containing 1-10% by weight of copper, based on the total weight of the zeolite or of the zeolite-like compound, said zeolite or said zeolite-like compound being selected from the group consisting of chabazite, SAPO-34, ALPO-34 and zeolite β; and
a homogeneous cerium-zirconium mixed oxide and/or a cerium oxide.
